(19) United States
(12) Patent Application Publication
(10) Pub. No.: US 2011/0095680 A1
(43) Pub. Date: Apr. 28, 2011

(54) METAL HALIDE DISCHARGE LAMP HAVING HIGH-PRESSURE BUFFER GAS

(75) Inventors: Andreas Kloss, Neubiberg (DE); Bernhard Schalk, Eching (DE)

(73) Assignee: OSRAM GESELLSCHAFT MIT BESCHRAENKTER HAFTUNG, Muenchen (DE)

(21) Appl. No.: 13/002,305

(22) PCT Filed: Jun. 5, 2009
(86) PCT No.: PCT/EP2009/056932

§ 371 Date: Dec. 31, 2010

(30) Foreign Application Priority Data
Jul. 2, 2008 (DE) 10 2008 031 257.6

(51) Int. Cl. H01J 61/12

(52) U.S. Cl. 313/571

(57) ABSTRACT

In various embodiments, a high-pressure discharge lamp that is intended to operate with system voltage. The high-pressure discharge lamp may include a discharge vessel that surrounds a discharge volume, a fill that contains metal halides, mercury and inert gas from the group of neon, argon, krypton and xenon being accommodated in the discharge volume, wherein the fill contains at least one of the halogens of iodine and bromine, a zero current phase in the power supply being bridged by selecting the cold fill pressure of the inert gas in the range of 4 to 8 bar.

### TECHNICAL FIELD

The invention proceeds from a high-pressure discharge lamp in accordance with the preamble of claim 1. Such lamps are, in particular, high-pressure discharge lamps including a ceramic discharge vessel, or else a silica glass vessel for general lighting.

### PRIOR ART

WO 98/25294 discloses a high-pressure discharge lamp in which a metal halide fill is used together with a ceramic discharge vessel. Moreover, the fill includes Hg and inert gas with a cold fill pressure of typically 250 mbar.

Trailing edge phase control is known, for example, from DE102005009940.

### SUMMARY OF THE INVENTION

The object of the present invention is to provide a high-pressure discharge lamp having a metal halide fill and Hg as well as inert gas and in the case of which simple means can be used to operate with a ballast designed for relatively high powers.

This object is achieved by the characterizing features of claim 1.

Particularly advantageous refinements are to be found in the dependent claims.

Reducing the power in the case of generic lamps is usually implemented by means of power blanking. Trailing edge phase control is a customary measure for this purpose. To this end, a current zero phase of greater or lesser length is installed in the temporally variable power feed. At the end of this zero phase of the current, current is intended to flow once again through the lamp. Since, however, the plasma cools during this zero phase, and thus reduces, or more or less loses, its electrical conductivity thereby, this constitutes a permanent restarting operation. This is associated with a corresponding restarting peak in the voltage. If this restarting voltage is higher than the available external voltage (drawn from the system voltage), the lamp is extinguished.

The cause of the restarting peak upon the resumption of the flow of current is the reduction in electrical conductivity which is associated with the cooling. The reduction is particularly pronounced, because metal halide fills contain free halogens. Due to their high electronegativity, the latter are particularly electron-consuming, this applying above all to iodide and bromide.

By contrast, this problem does not arise with lamp types that manage without halogen such as, for example, mercury or sodium high-pressure lamps.

In order to enable power blanking even in the case of a fill containing halogen, it is proposed in accordance with the invention to use an inert gas under high-pressure as a buffer gas. The pressure should in this case be between 4 and 8 bar. Preference is given to a cold fill pressure of between 5 and 7 bar, it being above all argon, krypton and neon and mixtures thereof that are suitable as inert gas. In comparison with xenon said inert gases enable lower restarting peaks. They are, moreover, much more cost effective.

A typical Hg content is in this case 25 to 200 μmol/cm³, corresponding to 5 to 40 mg/cm³ Hg.

The function of the inert gas here is not to provide instant light in the way well known for xenon under high-pressure, but to raise the absolute thermal capacity of the plasma substantially and thereby at the same time to raise the thermal conductivity only to a small extent.

The cooling of the plasma during the current zero phase is reduced with the aid of these measures. Consequently, the electrical conductivity is depressed to a lesser extent. The restarting voltage at the end of the current zero phase is reduced.

It is thereby possible to provide metal halide lamps that are used as a retrofit solution for conventional mercury high-pressure lamps that are in use in street lighting, for example. The novel lamps have a substantially better color rendering and, moreover, a higher efficiency when compared with mercury and sodium high-pressure lamps.

The discharge vessel preferably consists of aluminum-containing ceramic such as PCA, or else YAG, AlN, or AlYO3. However, it can also consist of silica glass. Either approach is known per se from the prior art. Again, selection of the metals for the fill is not subject to any particular restriction. Typical metals are rare earth metals, Na and thallium.

The newly presented concept is also suitable for mixed light lamps with a discharge vessel that has a metal halide fill. Here, an incandescent filament is used as a series resistor instead of an inductor.

The power reduction is preferably selected in the range from 95 down to 55%. It is preferred to use the trailing edge phase control as power blanking, but it is also the case that other concepts are not excluded. The voltage provided is a conventional AC voltage, sinusoidal and square wave voltages being typical. The concept is also suitable for ensuring against brief mains interruptions such as can occur in less developed countries.

The inventive concept is suitable chiefly for lamps of low power in the range of 15 to 400 W.

### BRIEF DESCRIPTION OF THE DRAWINGS

The aim below is to explain the invention in more detail with the aid of a plurality of exemplary embodiments. In the figures:

FIG. 1 shows a high-pressure discharge lamp having a discharge vessel;

FIG. 2 is a diagram that shows the principle of the trailing edge phase control;

FIG. 3 is a diagram that shows the restarting peak as a function of the duration of the trailing edge phase control;

FIG. 4 is a diagram that shows the restarting voltage as a function of the blanking time for various lamp types (4a) and (4b).

### PREFERRED EMBODIMENT OF THE INVENTION

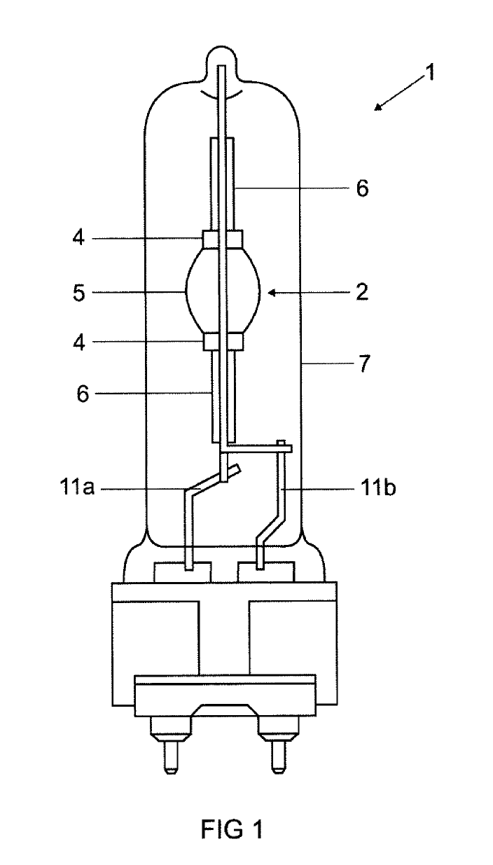

FIG. 1 is a schematic of a metal halide lamp 1. It includes a discharge vessel 2 made from ceramic into which two electrodes are introduced (not visible). The discharge vessel has a central part 5 and two ends 4. Seated at the ends are two seals 6 that are designed here as capillaries. The discharge vessel and the seals are preferably produced in one piece from a material such as PCA.

The discharge vessel 2 is surrounded by an outer bulb 7. The discharge vessel 2 is held in the outer bulb by means of a frame that includes a short and a long supply lead 11a and 11b.

The discharge vessel contains a fill that typically includes Hg (15 mg/cm³) and 5 to 30 mg/cm³ metal iodides. The iodides can be replaced in part or completely by bromides. A typical fill has Na, Dy, Tm, Ce and thallium as metals. Krypton under a pressure of 6 bar is used cold as inert gas.

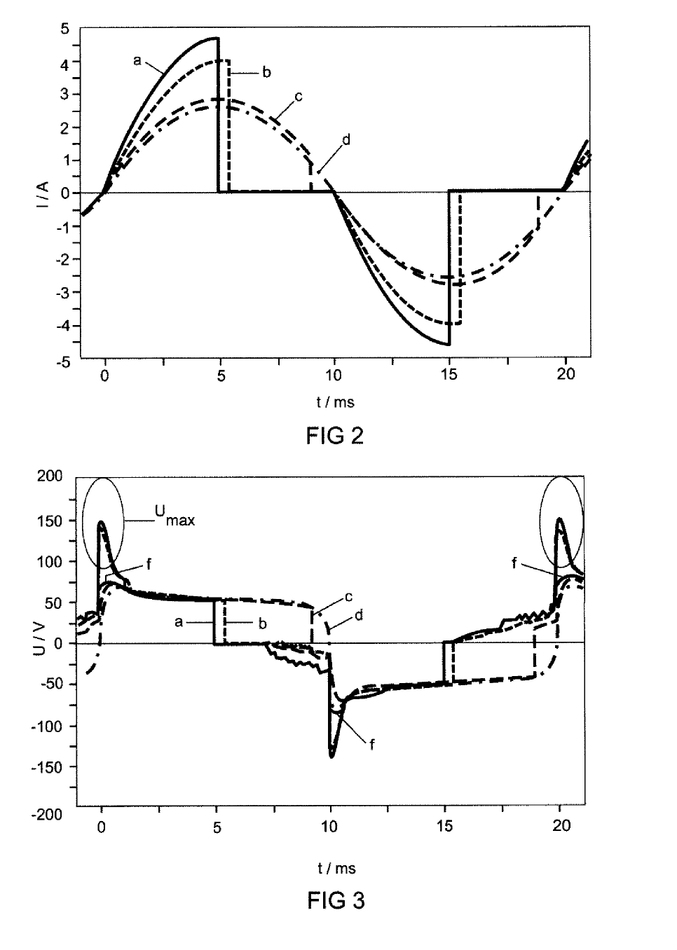

FIG. 2 is a schematic of a sinusoidal AC current source (curve d) on which a trailing edge phase control of between 50 and 100% is imposed, as a function of the time t (in ms). Curve c stands for 95%, curve b for 55% and curve a for 50%. The peak of the current I (in amperes) rises in this case with increasing duration of the phase section, and is largest for curve a, such that there is no need to accept losses in the luminous flux.

By way of example for the conditions of FIG. 2, FIG. 3 shows the influence of the duration of the zero current phase on the restarting behavior of the operating voltage U (in volts) of a conventional lamp without high inert gas pressure. The voltage profile exhibits no special feature for a missing (curve d) or slight zero current phase (curve c). With increasing zero current phase, which is in the range from approximately 0 to 50% of the entire phase duration, the restarting peak Uₘₐₓ increases substantially (curves b and a).

Absolute periods of the zero current phase up to approximately 5 ms can, however, be effectively bridged by a high cold fill pressure of inert gas. No restarting peaks are formed despite a long zero current phase (curve f).

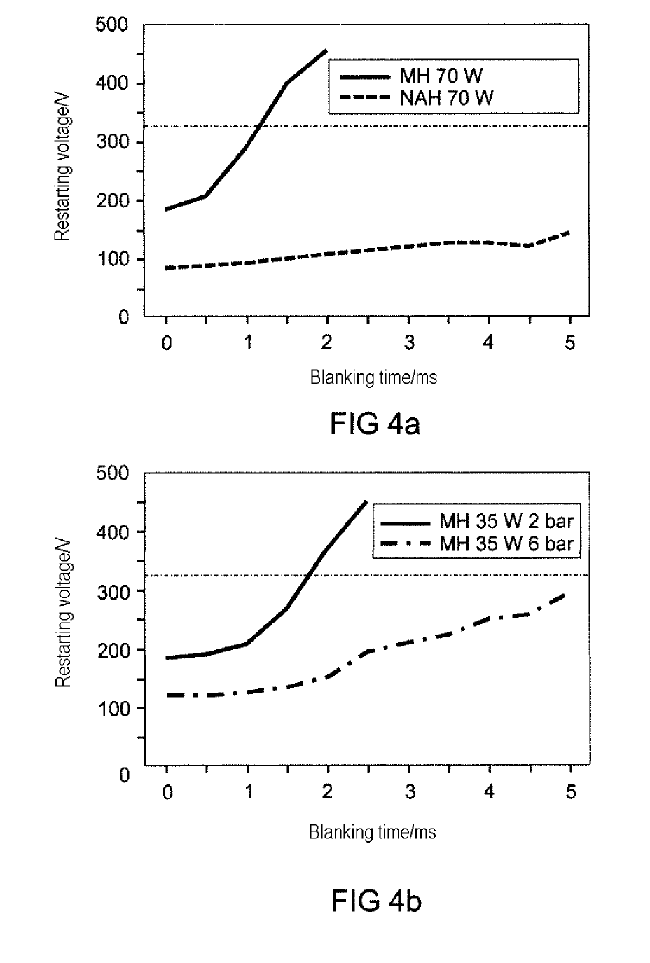

FIG. 4 shows the rise of the restarting voltage (in V) as a function of the blanking time (in ms) for various lamp types. In this case, the behavior for a conventional fill of a metal halide lamp MH (70 W power) with a low inert gas pressure (250 mbar) is shown in FIG. 4a (curve MH). After just 2 ms the restarting peak has already reached the critical value of 330 V, which represents the threshold for restarting at system voltage.

FIG. 4a further shows the conditions for a typical sodium high-pressure lamp (curve NAH), for which the problem does not exist owing to the lack of a fill containing halogen. As expected in this case, practically hardly any rise in the restarting voltage is to be observed.

In an inventive fill (curve MH 35 watt, 6 bar argon) in FIG. 4b), this critical value is still not reached even after 5 ms, in contrast with a fill with 2 bar inert gas pressure, curve MH 35 watt 2 bar argon).

In this particular exemplary embodiment, the time window of 5 ms is the maximum value of a zero current phase that can occur from a blanking of down to at most 55%. Consequently, a reliable restarting is ensured in the next phase despite maximum blanking.

1. A high-pressure discharge lamp that is intended to operate with system voltage, the high-pressure discharge lamp comprising:
a discharge vessel that surrounds a discharge volume,
a fill that contains metal halides, mercury and inert gas from the group of neon, argon, krypton and xenon being accommodated in the discharge volume,
wherein the fill contains at least one of the halogens of iodine and bromine, a zero current phase in the power supply being bridged by selecting the cold fill pressure of the inert gas in the range of 4 to 8 bar.

2. The high-pressure discharge lamp as claimed in claim 1, wherein the zero current phase can be deliberately controlled by a power blanking that reaches down to 55% of the entire phase duration of the system voltage.

3. The high-pressure discharge lamp as claimed in claim 2, wherein the power blanking is attained by trailing edge phase control.

4. The high-pressure discharge lamp as claimed in claim 1, wherein the inert gas is argon, krypton or neon.

5. The high-pressure discharge lamp as claimed in claim 1, wherein the cold fill pressure of the inert gas is selected in the range of 5 to 7 bar.

6. The high-pressure discharge lamp as claimed in claim 1, wherein the content of Hg is selected in the range of 5 to 40 mg/cm³.

7. The high-pressure discharge lamp as claimed in claim 1, wherein the discharge vessel is fabricated from ceramic.

8. The high-pressure discharge lamp as claimed in claim 1, wherein the lamp is a retrofit lamp for street lighting.

9. The high-pressure discharge lamp as claimed in claim 1, wherein the zero current phase extends over a period of up to 5 ms.
